(19) United States
(12) Patent Application Publication
(10) Pub. No.: US 2026/0211564 A1
(43) Pub. Date: Jul. 23, 2026

(54) STORAGE META DATA INTERROGATION

(71) Applicant: Arm Limited, Cambridge (GB)

(72) Inventors: Daren CROXFORD, Swaffham Prior (GB); Graeme Leslie INGRAM, Melbourn (GB); Remy POTTIER, Grenoble (FR)

(21) Appl. No.: 19/032,890

(22) Filed: Jan. 21, 2025

(51) Int. Cl. G06F 3/06

(52) U.S. Cl. CPC G06F 3/0625; G06F 3/0644; G06F 3/0673

(57) ABSTRACT

Systems and methods for determining whether a region of storage has associated meta data. A storage controller can receive, from a requestor, a request for meta data associated with a region of storage, determine whether the region of storage has associated meta data, and when region of storage has associated meta data, obtain, the meta data associated with the region of storage, and send, from the storage controller to the requestor, a response based at least in part on the associated meta data.

### FIELD

The present technology relates to storage meta data, in particular to methods at a storage controller and a requestor for determining whether a region of storage has associated meta data.

### BACKGROUND

When processing data, various units of a system may need to retrieve data from storage. For example, when an image is to be rendered on the display of a user device, a display controller of the display will read image data from a frame buffer. The image is stored in the frame buffer by e.g. a graphics processor, and when it is ready for display the display controller will read the frame buffer and provide the image to the display. The frame buffer itself is typically located in storage which is external to the display controller and the graphics processor, such as in the so-called “main” memory of the system. The reading of data from frame buffers can consume a relatively significant amount of power and memory bandwidth.

To reduce memory bandwidth, data can be stored in external storage in a compressed format. Various compression schemes exist for converting uncompressed data into compressed data. When required, the compressed data in external storage may be retrieved and decompressed, but doing so requires knowledge of the location of that data in storage, as well as knowledge of the compression scheme used. Furthermore, the compression and decompression of data can place a large burden on the storage subsystem, both in terms of energy consumption and processing time.

### SUMMARY

An aspect of the present technology provides a method at a storage controller, a method at a requestor and a system comprising a storage controller according to the appended claims.

Another aspect of the present technology provides a method at a storage controller, the method comprising:
receiving, from a requestor, a request for meta data associated with a region of storage, wherein the request comprises an indication of the region of storage; and
determining whether the region of storage has associated meta data,
wherein when the region of storage has associated meta data, the method further comprises:
obtaining the meta data associated with the region of storage; and
sending, to the requestor, a response based at least in part on the associated meta data.

Optionally, the region of storage has associated meta data when the region of storage comprises compressed data.

Optionally, the meta data is meta data associated with the region of storage or computed from the region of storage.

Optionally, the response based at least in part on the meta data comprises an indication of the number of meta data regions included in the region of storage.

Optionally, the response based at least in part on the associated meta data comprises meta data associated with each meta data region included in the region of storage.

Optionally, the response based at least in part on the meta data comprises information about one or more characteristics of interest, wherein the one or more characteristics of interest include one or more of transparency information, opaqueness information, all zero information, all same value information and compression information.

Optionally, the method further comprises:
determining the number of meta data regions included in the region of storage; and
comparing the number of meta data regions included in the region of storage with a first threshold,
wherein when the number of meta data regions included in the region of storage meets the first threshold, the method comprises refusing the request, and
wherein when the number of meta data regions included in the region of storage does not meet the first threshold, the method comprises accepting the request.

Optionally, the method further comprises:
determining the number of meta data regions that are overlapped by the region of storage; and
comparing the number of meta data regions that are overlapped by the region of storage with a second threshold,
wherein when the number of meta data regions that are overlapped by the region of storage meets the second threshold, the method comprises:
sending, to the requestor, a response comprising the meta data for all meta data regions that are overlapped by the region of storage, and
wherein when the number of meta data regions included in the region of storage does not meet the second threshold, the method comprises:
combining the meta data for all meta data regions that are overlapped by the region of storage; and
sending, to the requestor, a response comprising the combined meta data for all meta data regions that are overlapped by the region of storage.

Optionally, the combined meta data comprises at least one combined value corresponding to the meta data regions that are overlapped by the region of storage.

Optionally, obtaining the meta data associated with the region of storage comprises reading header data and wherein the header data comprises a pointer to a body block containing compressed data.

Optionally, the header data comprises information about one or more characteristics of interest, wherein the one or more characteristics of interest include one or more of transparency information, opaqueness information, all zero information, all same value information and compression information.

Optionally, determining whether the region of storage has associated meta data comprises: determining whether the region of storage has associated meta data that is relevant for the requestor.

Optionally, the region of storage is a 1D storage region, a 2D storage region or a 3D storage region.

Another aspect of the present technology provides a method at a requestor, the method comprising:
sending, to a storage controller, a request for meta data associated with a region of storage, wherein the request comprises an indication of the region of storage;
receiving, from the storage controller, a response based on the associated meta data; and
determining, based at least in part on the response from the storage controller, whether to fetch data in the region of storage.

Optionally, the indication of the region of storage comprises size information and offset information.

Optionally, the request comprises an indication of one or more characteristics of interest, wherein the one or more characteristics of interest include one or more of transparency information, opaqueness information, all zero information, all same value information and compression information.

Optionally, the method further comprises: sending, to the storage controller, a request for at least some of the data in the region of storage.

Optionally, if the response based on the associated meta data is not available to the requestor within a predetermined amount of time, the request for at least some of the data in the region of storage is sent to the storage controller before the response based on the associated meta data is received from the storage controller.

Another aspect of the present technology provides a system comprising a storage controller, the storage controller being configured to carry out a method comprising:
receiving, by the storage controller from a requestor, a request for meta data associated with a region of storage, wherein the request comprises an indication of the region of storage; and
determining, by the storage controller, whether the region of storage has associated meta data,
wherein when region of storage has associated meta data, the method further comprises:
obtaining, by the storage controller, the meta data associated with the region of storage; and
sending, from the storage controller to the requestor, a response based at least in part on the associated meta data.

Optionally, the system further comprises: the requestor; a system interconnect; and a storage element comprising the region of storage.

Optionally, the requestor is in communication with the requestor via the system interconnect.

Optionally, the storage controller is in communication with the storage element comprising the region of storage.

Optionally, the system interconnect comprises a compressor and/or a decompressor.

Optionally, the requestor is a cpu, a gpu or a display controller.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Embodiments will now be described, with reference to the accompanying drawings, in which:

FIG. 1 shows an exemplary system;

FIG. 2 shows a further exemplary system;

FIG. 3 shows several exemplary compression schemes;

FIG. 4 shows an exemplary method to be carried out at a storage controller;

FIG. 5 shows an exemplary method to be carried out at a requestor;

FIG. 6 shows an exemplary image stored as compressed blocks in storage;

FIG. 7 shows a further exemplary method to be carried out at a storage controller;

FIG. 8 shows a yet further exemplary method to be carried out at a storage controller;

FIG. 9 shows exemplary requests and responses for a storage controller; and

FIG. 10 shows an exemplary storage regions in 2D and 3D storage.

### DETAILED DESCRIPTION

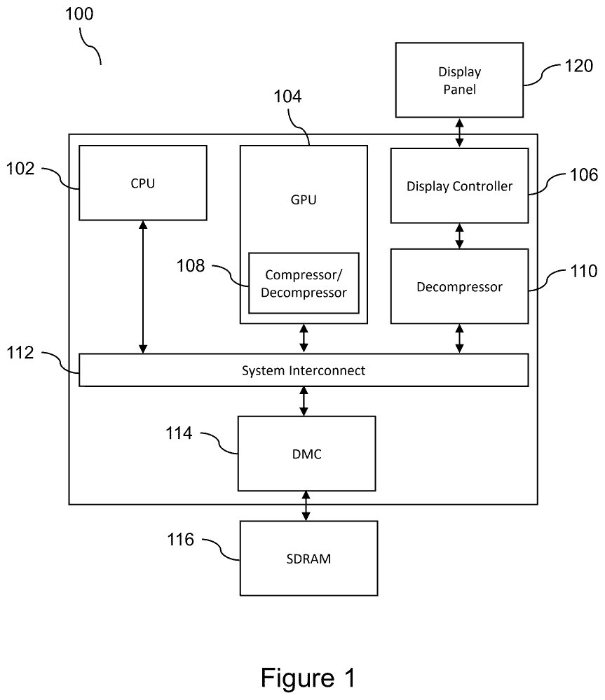

FIG. 1 shows an exemplary system 100. The system 100 comprises a plurality of units including a Central Processing Unit (CPU) 102, a Graphics Processing Unit (GPU) 104 and a display controller 106 which is configured to output image data to a display panel 120. The CPU, GPU and display controller are able to retrieve data from external storage 116, in this example Synchronous Dynamic Random Access Memory (SDRAM) such as Double Data Rate SDRAM (DDR-SDRAM), via a system interconnect 112 and a Dynamic Memory Controller (DMC) 114. DMC 114 is a high-performance, area-optimized SDRAM or Mobile SDR or DDR memory controller.

To minimize memory bandwidth, memory access energy consumption and memory space, data can be stored in external storage 116 in compressed format. In the example of FIG. 1, the GPU 104 includes an integrated compressor/decompressor codec 108. The GPU 104 can send compressed data to the external storage 116 via the system interconnect 112 and “DMC” 114. When the display controller needs to read the compressed data from the external storage 116, it will need to request the compressed data from the external storage 116 and decompress it. Decompression either requires the display controller to be able to decompress the data internally, or to use an external decompression unit 110 (as shown). In the example of FIG. 1, the CPU 102 cannot natively compress and/or decompress compressed data, and therefore would potentially need to perform any compression and/or decompression of data in software.

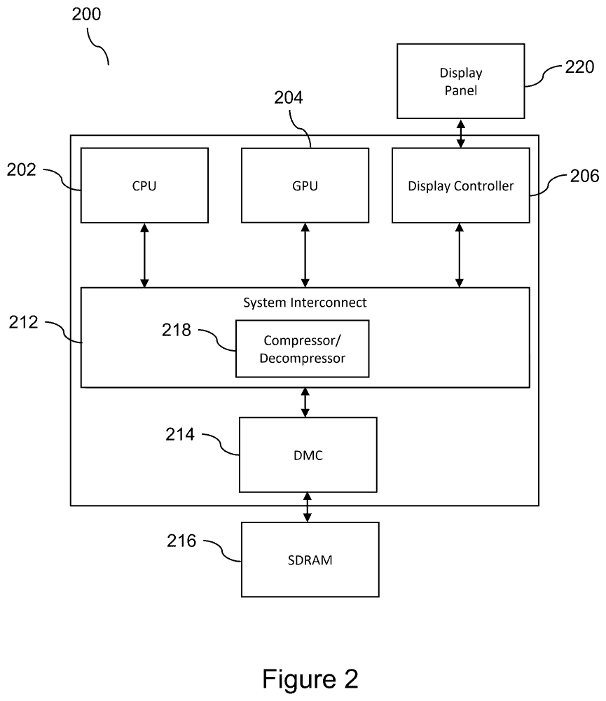

FIG. 2 shows a further exemplary system 200. The further exemplary system 200 is similar to the system 100 shown in FIG. 1, with similar numerals (e.g. 102/202, 116/216) denoting similar features. The system 200 also comprises a plurality of units including a CPU 202, a GPU 204 and a display controller 206 which is configured to output image data to a display panel 220. The CPU, GPU and display controller are able to retrieve data from external storage 116, in this example SDRAM, via a system interconnect 212 and DMC 214.

The further exemplary system 200 shown in FIG. 2 is distinguished from the system 100 shown in FIG. 1 by the system interconnect 212 having a native compressor/decompressor 218. As will be appreciated, the compressor/decompressor 218 can be located in the system interconnect 212 as shown, or in another component of the exemplary system 200. For example, the compressor/decompressor 218 may be located in a system level cache (SLC), or may be a separate component that is located before the DMC 214. In the example of FIG. 1 a single DMC is shown. However, in other examples the exemplary system 200 and compressor/decompressor 218 may include multiple DMCs, where each DMC may be independent or may be striped. Any requestor of data in the external storage 216 (e.g. the CPU 202, GPU 204 or display controller 206) can use the compressor/decompressor 218 to compress or decompress compressed data without having to compress or decompress the data internally.

According to this example, a data requestor such as CPU 202, GPU 204 or display controller 206 can be completely agnostic as to whether the storage region it requests is compressed, and any compression scheme used. Integrating the compressor/decompressor 218 in the storage system means that any requestor will effectively see an “uncompressed” view of storage 216 as provided by the appropriately configured compressor/decompressor 218. As will be appreciated, the term “storage” should be interpreted to include “memory”, and the term “storage system” should be construed accordingly.

Advantageously, integrating the compression/decompression engine in the storage system allows devices which make use of compression schemes to be agnostic to (and potentially unaware of) the particular compression algorithm used. Where a single compression/decompression engine can provide the required throughput, the storage system requires only one compression/decompression engine for use by multiple devices, and the compression scheme can be selected and managed easily for all devices. However, it should be noted that any device using the compression and decompression engines may not be aware of how the data is compressed, and therefore may be less able to optimise processing accordingly.

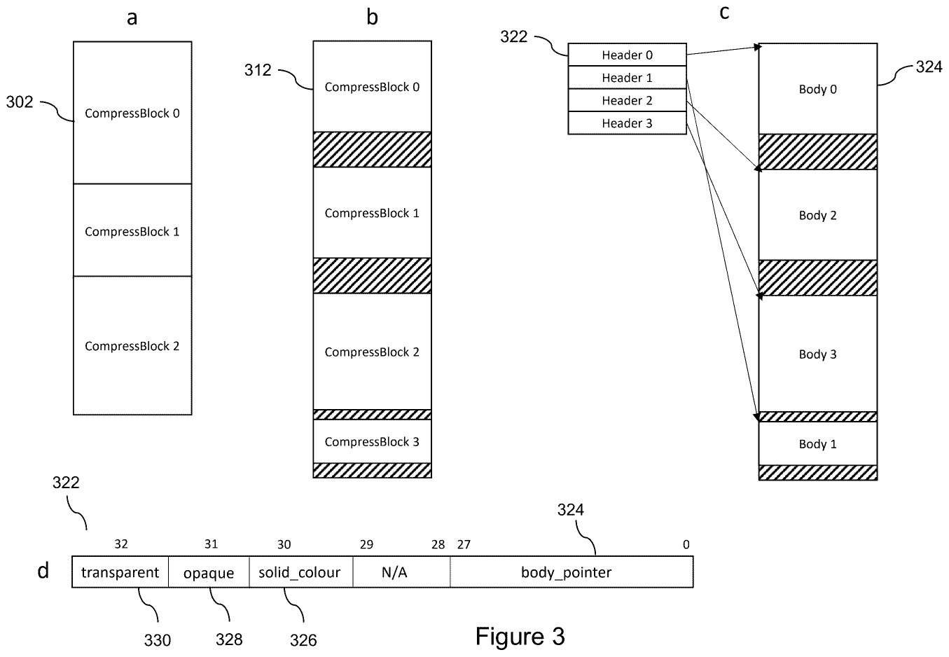

FIG. 3 shows a plurality of compression schemes which may be used by e.g. the compressor/decompressor 108 and compressor/decompressor 218 shown in FIGS. 1 and 2. Depending upon the goal of the compression scheme, the layout of the compressed data in storage may be different.

In compression scheme a, for example, the goal is to minimize the footprint of data stored in storage (including in memory). Different compression blocks are compressed by different amounts and the compressed blocks are stored adjacent to each other.

For compression scheme b, the goal is to compress a block, but also to have deterministic placement of the data, which may be useful when the contents of a CompressBlock are subject to changes. For example, where a CompressBlock is to be re-compressed and/or overwritten with a new CompressBlock, there will be enough space for the new CompressBlock to be stored without having to move any surrounding CompressBlocks. Although this scheme does not save storage space, this scheme is good to minimize memory bandwidth when fetching the data.

In a third example compression scheme c, headers 322—which provide information about compression blocks and pointers to the compression data—may be stored separately from each a body block 324. Each header 322 and/or the body block 324 may contain information about the compressed data. The order of the headers in storage may indicate the arrangement of uncompressed data. For example, the first header may be for a first block of data, the next header may be for the next block of data, etc. In contrast, the order of the body blocks in storage/memory is irrelevant.

Panel d of FIG. 3 shows a typical header 322 comprising a body pointer 324 (bits 0 to 27), solid colour information 326 (bit 30), opaqueness information 328 (bit 31) and transparency information 330 (bit 32). The body pointer 324 is a pointer to the location in storage of the start of the respective body block 324. The solid colour information 326 may for example indicate whether the compressed data in the body block is a single solid colour (in which case, bit 30=1; otherwise, bit 30=0). The opaqueness information 328 and transparency information 330 may indicate whether the compressed data in the body block is opaque or transparent, respectively. Where the compressed data is completely opaque, bits 31 and 32 may have the values [1, 0]. Where the compressed data is completely transparent, bits 31 and 32 may have the values [0, 1]. Where the compressed data is not completely opaque and not completely transparent, bits 31 and 32 may have the values [0, 0]. Where bits 31 and 32 have the values [1, 1] then the opaqueness/transparency of the compressed data is not defined (“N/A”).

The initial portion of data in a compression block will often provide information (i.e. meta data) on how data in that region of storage is stored and/or compressed. Such meta data may be generated when the data is compressed, for example by the compressor/decompressor 108 or compressor/decompressor 218. The meta data may be provided explicitly, the explicit meta indicating a particular characteristic of the data that was compressed, or implicitly for example the size of the compressed block may indicate a particular characteristic of the data that was compressed. Generated meta data may comprise information about one or more characteristics of the compressed data, and such information may be of interest and useful to a requestor when retrieving data.

For example, when the meta data for a particular block includes transparency information, i.e. information about whether all of the data in the block is transparent, then a data requestor can decide whether or not to retrieve the data based on an inspection of the meta data. Where the meta data indicates that all of the data in the block is transparent, then a requestor such as a display controller can decide not to retrieve that data, since it may not need to be rendered.

In another example, where the meta data includes opaqueness information, i.e. information about whether all of the data in the block is opaque, then a data requestor can decide whether or not to retrieve any further data based on an inspection of the meta data. Where the meta data indicates that all of the data in the block is opaque, then a requestor such as a display controller can decide not to retrieve data for layers behind the opaque layer, since such layers may not need to be rendered.

In other examples, the meta data may include all zero information (i.e. information indicating whether all of the data in the block has a value of “0”) or all same value information (i.e. information indicating whether all of the data in the block has the same value, e.g. “1”). Where the meta data indicates that all of the data in the block has a particular value, then a requestor may decide to populate the data of a block locally, rather than retrieving the data from storage.

As will be appreciated, the meta data may include any other suitable compression information, such as compression data size, and such information may be used by a requestor when deciding whether to retrieve data from storage. For example, if the compressed data block is small (implicit from meta data) then the overhead of fetching the data will be small and decompressing the data is likely to be relatively simple. Therefore, fetching such data will likely have little overhead. In contrast, if the compressed data block is large then the overhead of fetching the data block will be high, and therefore the requestor may wish to ensure that the data is useful before fetching it. The usefulness of the data may be determined via inspection of the meta data.

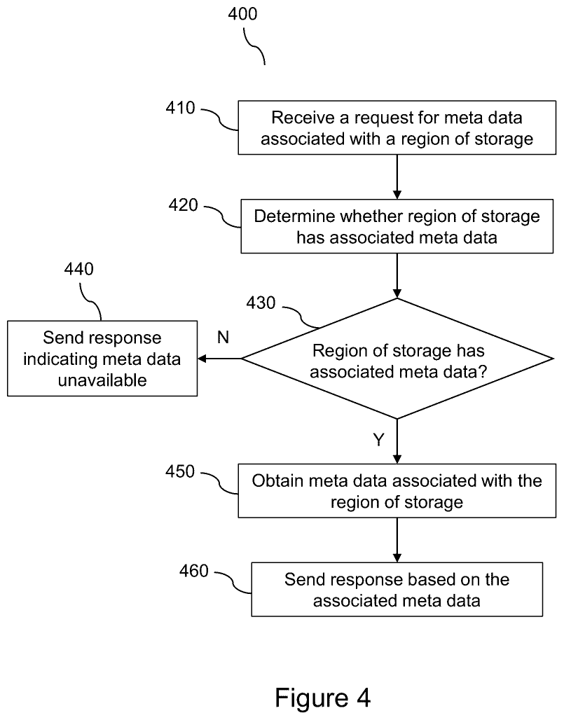

FIG. 4 shows a method 400 to be carried out at a storage controller, which may also be referred to as a “Region handler”. The storage controller is interrogated, determines whether a region is compressed, and if there is requested meta data. The storage controller may be a compressor/decompressor in the storage system, for example the compressor/decompressor 218 shown in FIG. 2. Advantageously, the method 400 allows the storage controller to provide information to a requestor regarding data in storage, for example data in SDRAM 216 shown in FIG. 2. In particular, the method 400 enables the storage controller (e.g. compressor/decompressor 218 in FIG. 2) to send a request to the storage SDRAM 216 via the DMC 214, and to provide meta data to the requestor, providing the requestor with suitable information to decide e.g. whether to fetch data in the region of storage.

The method 400 allows a requestor to interrogate a compressed data region and to determine its characteristics, and then to provide protocol agnostic meta data. The method 400 allows a requestor to find out whether a particular region has associated meta data. In an example a region may be compressed and the region may have compression meta data. An uncompressed region may also have meta data associated with it. The meta data for a region, if available, is accessed and provided as protocol agnostic meta data.

At step 410, the method 400 comprises receiving a request for meta data associated with a region of storage. By “meta data” it is meant information on how data in that region of storage is stored and/or compressed. In examples, the meta data may be meta data associated with the region of storage or computed from the region of storage.

The request for meta data is received from a requestor, which may be a CPU, a GPU or a display controller, such as the CPU 202, GPU 204 or display controller 206 shown in FIG. 2.

In examples, the request received at step 410 comprises an indication of the region of storage, particularly the region of storage that the requestor is interested in. The region of storage may be a 1D storage region, a 2D storage region or a 3D storage region. The indication of the region of storage may comprise size information and offset information.

In further examples, the request comprises information about one or more characteristics of interest such as one or more of transparency information, opaqueness information, all zero information, all same value information and compression information. The meta data that can be provided to the requestor is dependent on the compression scheme used.

At step 420, the method 400 comprises determining whether the region of storage has associated meta data. In other words, at step 420 the storage controller determines whether there is any meta data associated with the region of storage indicated in the request received in step 410. In examples, the storage controller, which may be compressor/decompressor 218, sends an appropriate request to the DMC 214 shown in FIG. 2 to access storage in the SDRAM 216.

Determining whether the region of storage has associated meta data may include determining whether the region of storage has associated meta data that is relevant for the requestor. In some examples, the region of storage has associated meta data only when the region of storage comprises compressed data. When data is compressed, for example by the compressor/decompressor 108 or compressor/decompressor 218, meta data may be generated. Such meta data may comprise information about one or more characteristics of the compressed data, such as of transparency information, opaqueness information, all zero information, all same value information and compression information.

The generated meta data may be stored e.g. at the beginning of the body portion of the compressed block, and/or in a header of the compressed block. The header of the compressed block may be located in storage adjacent to the body portion, or may be located in a separate region of storage.

After determining whether the region of storage has associated meta data at step 420, the method proceeds to step 430.

If, on reaching step 430, it has been determined that the region of storage has no associated meta data, then the “N” branch from step 430 is followed. The “N” branch from step 430 may be followed both in cases where the region of storage has no associated meta data, or has some associated meta data but that associated meta data is determined not to be relevant for the requestor. On following the “N” branch from step 430, method 400 proceeds to step 440 where a response indicating that meta data is unavailable is sent to the requestor.

If, on reaching step 430, it has been determined that the region of storage does have associated meta data (e.g. associated meta data that is relevant for the requestor) then the “Y” branch from step 430 is followed. On following the “Y” branch from step 430, method 400 proceeds to step 450 where meta data associated with the region of storage is obtained. To obtain the meta data associated with the region of storage at step 450, the storage controller interrogates the compression protocol. In examples, the obtained meta data is compression protocol agnostic.

Obtaining the meta data associated with the region of storage at step 450 may comprise reading header data. Such header data may comprise a pointer to a body block containing compressed data. In examples, the header data comprises information about one or more characteristics of interest, including one or more of transparency information, opaqueness information, all zero information, all same value information and compression information. Alternatively, if the meta data region is compressed data (without header), the compressed data may be interrogated directly. Further, if the meta data region is not compressed, the associated meta data may be accessed.

After obtaining meta data associated with the region of storage at step 450, the method 400 proceeds to step 460. At step 460, the method 400 comprises sending a response based at least in part on the associated meta data.

In examples, the response based at least in part on the associated meta data may comprise meta data associated with each meta data region included in the region of storage. By “meta data region” it is meant a block or unit of stored data at least partially located in the region of storage for which meta data can be provided to the requestor.

In further examples, the response based at least in part on the meta data may additionally or alternatively comprise an indication of the number of meta data regions included in the region of storage.

In yet further examples, the response based at least in part on the meta data may additionally or alternatively comprise information about one or more characteristics of interest. The one or more characteristics of interest may include one or more of transparency information, opaqueness information, all zero information, all same value information and compression information.

The storage controller can provide the requestor with access to the available meta data in multiple ways. For example, the storage controller may provide an address window on the compressed data, and a separate window may be provided for the compression meta data.

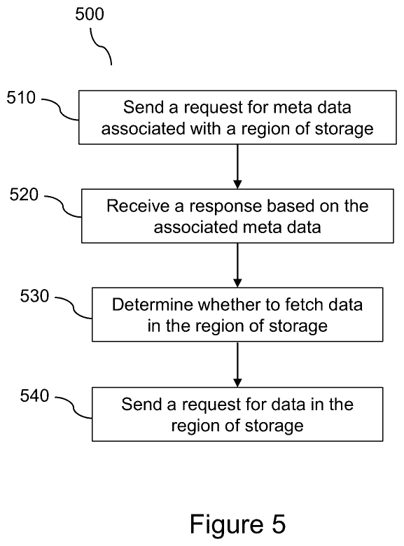

FIG. 5 shows a method 500 to be carried out at a requestor, which may be a CPU, a GPU or a display controller, such as the CPU 202, GPU 204 or display controller 206 shown in FIG. 2. As will be appreciated, the method 500 corresponds to the ‘requestor-side actions’, in contrast to the ‘storage controller-side actions’ exemplified by the method 400.

Advantageously, the method 500 allows the requestor to request (and obtain) information from a storage controller regarding data in storage, for example data in SDRAM 216 shown in FIG. 2. In particular, the method 500 enables the requestor to request meta data from the storage controller. Based on the information received, the requestor can determine whether or not it would be efficient or necessary to obtain data from a region of storage.

At step 510, the method 500 comprises sending a request for meta data associated with a region of storage. The request for meta data is sent to the interconnect 212, and interpreted by the Compressor/Decompressor 218, which then sends an appropriate request to the DMC 214 shown in FIG. 2 to access storage in the SDRAM 216.

In examples, the request comprises an indication of the region of storage, particularly the region of storage that the requestor is interested in. The region of storage may be a 1D storage region, a 2D storage region or a 3D storage region. The indication of the region of storage may comprise size information and offset information.

In further examples, the request comprises information about one or more characteristics of interest, such as one or more of transparency information, opaqueness information, all zero information, all same value information and compression information.

At step 520, the method 500 comprises receiving, from the storage controller, a response based on the associated meta data. As noted above, the response based at least in part on the associated meta data may comprise meta data associated with each meta data region included in the region of storage, an indication of the number of meta data regions included in the region of storage and/or information about one or more characteristics of interest. The one or more characteristics of interest include one or more of transparency information, opaqueness information, all zero information, all same value information and compression information.

At step 530, the method 500 comprises determining, based at least in part on the response from the storage controller, whether to fetch data in the region of storage. This determination may be based on meta data and/or information about one or more characteristics of interest received as part of the response from the storage controller.

In an example, the region of storage may comprise zero chunks of data i.e. all data values of “0”. Where the requestor can determine, based on the response, meta data and/or information received at step 520, that the data in the region of storage is all “0”, then the requestor can decide not to fetch that data. Instead, the requestor may e.g. populate the data locally, saving the power and energy that would be required to fetch the data. As will be appreciated, similar techniques can be applied to any region of storage comprising chunks of data having all the same value (e.g. “1”). The requestor may be able to determine that the data in a region of storage will be all “0” or all the same value based e.g. on the size of the compressed data; where a compressed meta data region is small (e.g. 10 bytes long) it may be inferred that the data in that region is all “0” or all the same value. A common use case in graphics processing is alpha blending of frame buffers. Frame buffers typically store compressed data to minimise memory bandwidth.

Frame buffers tend to be relatively large and are often blended at a display rate of e.g. 30, 60, 90 or 120 fps. In an example, a first frame buffer may store a background region, a second frame buffer may store a foreground region, and these regions may need to be blended by a GPU, composition engine or display controller. If meta data associated with the first frame buffer indicates that a region of the foreground is opaque, further other frame buffers (e.g. the background frame buffer) for that region need not be fetched as that region of the background frame buffer will not be visible. Conversely, if meta data associated with the first frame buffer indicates that a foreground region is completely transparent, then that frame buffer need not be fetched and another frame buffer (e.g. the background frame buffer) for that region can be interrogated.

At optional step 540, the method 500 comprises sending, to the storage controller, a request for at least some of the data in the region of storage. Where the compression scheme used by e.g. compressor/decompressor 218 supports rotation of data, the request for at least some of the data in the region of storage may include a request that the data is returned rotated (e.g. by 90, 180 or 270 degrees).

If the response of step 520 is not available to the requestor within a predetermined amount of time after step 510 (e.g. 0.1, 1 or 10 seconds), then the request of step 540 may be sent to the storage controller before (or regardless of whether) the response of step 520 is received. In other words, the storage controller may only wait for the response of step 520 for the predetermined amount of time before sending the request for data in step 540. This is important in cases where the requestor has tight latency requirements.

By providing a way to access meta data, the present disclosure allows for the optimisation of storage transfers and may provide significant bandwidth, storage and energy savings. Using the techniques described herein, the amount of data needed to be decoded and sent to the storage system may be reduced, thereby limiting cache.

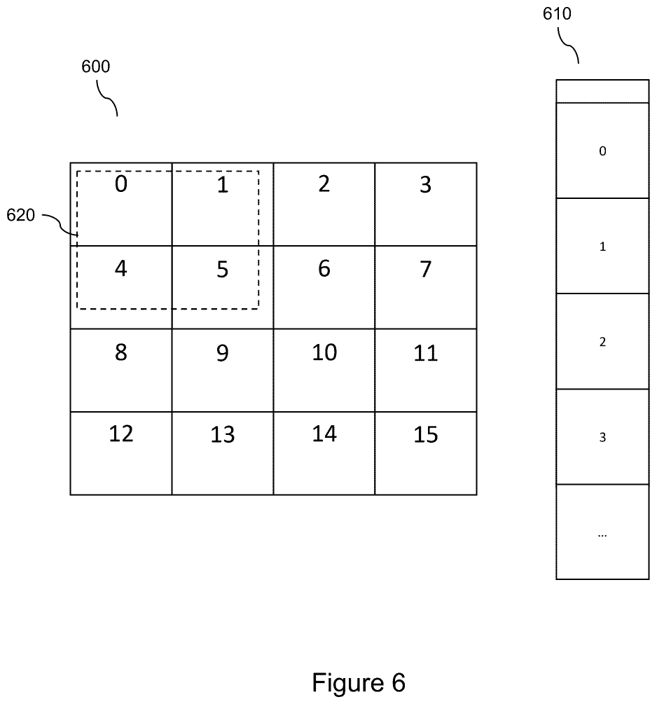

FIG. 6 shows an example compressed image 600 which has been stored as compressed blocks in storage 610. For illustrative purposes, the methods 400 and 500 will now be described with respect to the example of FIG. 6.

In this example, the method 400 begins at step 410 in which the storage controller receives, from a requestor, a request for meta data associated with a region of storage. As will be appreciated, the storage controller receives the request at step 410 as a result of the requestor sending the request to the storage controller at step 510 of method 500.

The request received at step 410 comprises an indication of a region of storage 620. As shown in FIG. 6, the region of storage 620 overlaps parts of blocks 0, 1, 4 and 5 of the compressed image 600. In this example, the request received at step 410 also comprises information about one or more characteristics of interest, in particular transparency information and opaqueness information.

At step 420, the storage controller determines whether the region of storage 620 has associated meta data.

In this example, the region of storage 620 does have associated meta data relevant to the requestor and therefore the method 400 proceeds to step 450 where meta data associated with the region of storage 620 is obtained by the storage controller, for example by reading header data associated with each of the blocks 0, 1, 4 and 5 in storage 610.

After obtaining meta data associated with the region of storage at step 450, the method 400 proceeds to step 460. At step 460, the method 400 comprises sending a response based at least in part on the associated meta data. In the present illustrative example, the response comprises meta data associated with each of the blocks 0, 1, 4 and 5 (i.e. each meta data region) in storage 610.

The requestor receives the response based at least in part on the associated meta data at step 520 of method 500. As noted above, the request received at step 410 includes information about one or more characteristics of interest, in particular transparency information and opaqueness information.

The requestor can use the information obtained at step 520 to determine whether to fetch data in the region of storage 620 at step 530. Advantageously, the requestor can use e.g. meta data to determine whether or not it would be efficient or necessary to obtain data from a region of storage.

For example, if the meta data for each of the blocks 0, 1, 4 and 5 indicates that the compressed image 600 is transparent in those regions, then the requestor can decide not to fetch the data corresponding to the region of storage 620.

In another example, if the meta data for each of the blocks 0, 1, 4 and 5 indicates that the compressed image 600 is opaque in those regions, then the requestor can decide to fetch the data corresponding to the region of storage 620, but not fetch any data for layers behind. Furthermore, the requester (e.g. a GPU, composition engine or display controller) may have tight latency requirements. For example, in some cases a composited frame must be available to be sent to a panel for display within a specific period otherwise the image displayed will be corrupted. In such cases, the requestor may ignore the meta data if it is not available (returned) in time, and may proceed without using the meta data.

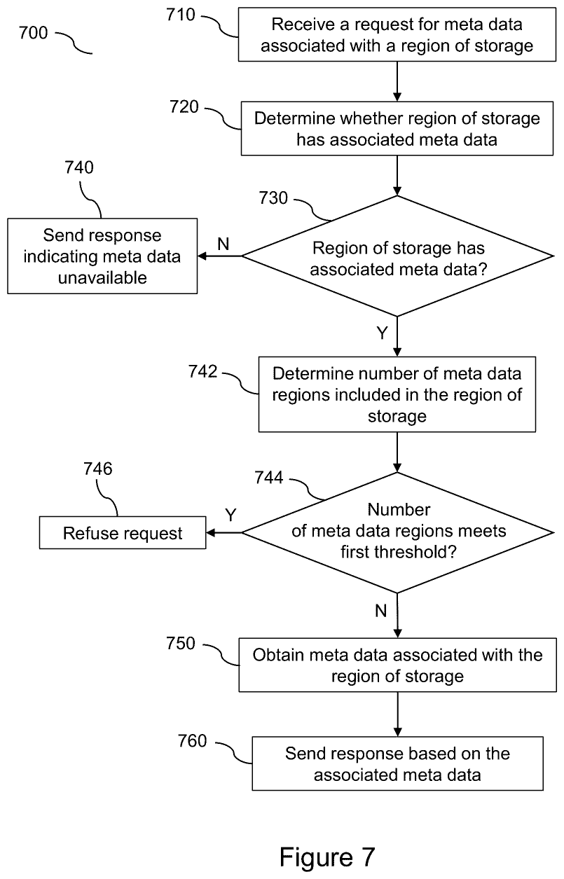

FIG. 7 shows a method 700 to be carried out at a storage controller, for example the compressor/decompressor 218 shown in FIG. 2. Advantageously, the method 700 allows the storage controller to provide information to a requestor regarding data in storage, for example data in SDRAM 216 shown in FIG. 2. In particular, the method 700 enables the storage controller to provide meta data to the requestor, providing the requestor with suitable information to decide whether to fetch data in the region of storage.

The method 700 is similar to the method 400 described above, with similar numerals (e.g. 410/710 and 450/750) denoting similar steps. The method 700 is distinguished from the method 400 by inclusion of the steps 742, 744 and 746.

In a similar manner to method 400, the method 700 comprises receiving a request for meta data associated with a region of storage (step 710), determining whether the region of storage has associated meta data (step 720) and, if the region of storage does not have associated meta data (step 730), sending a response indicating that meta data is unavailable (step 740).

If, on reaching step 730, it has been determined that the region of storage does have associated meta data, then the “Y” branch from step 730 is followed. On following the “Y” branch from step 730, method 700 proceeds to step 742 where the number of meta data regions included in the region of storage is determined.

After determining the number of meta data regions included in the region of storage at step 742, the method proceeds to step 744. At step 744, the number of meta data regions included in the region of storage is compared with a first threshold.

If it is determined at step 744 that the number of meta data regions included in the region of storage meets the first threshold, then the “Y” branch from step 744 is followed. On following the “Y” branch from step 744, the method 700 proceeds to step 746 where the request for meta data is refused. Refusing the request may involve sending a response to the requestor indicating that there are too many meta data regions in the region of storage.

In this example, the first threshold is used to limit the amount of processing, power consumption and/or storage use at the storage controller. Where the number of meta data regions included in the region of storage meets the first threshold (e.g. the first threshold is 20 meta data regions and the number of meta data regions included in the region of storage is 21) the request is not performed since it would require too much computation/energy/storage use. The first threshold may be parameterizable by the storage system on a temporal basis (e.g. to prevent excessive processing or energy use) and/or on a spatial basis (e.g. to prevent excessive storage use).

If it is determined at step 744 that the number of meta data regions included in the region of storage does not meet the first threshold, then the “N” branch from step 744 is followed. As will be appreciated, following the “N” branch from step 744 constitutes accepting the request for meta data. On following the “N” branch from step 744, the method 700 proceeds to steps 750 and 760, which are similar to steps 450 and 460, respectively.

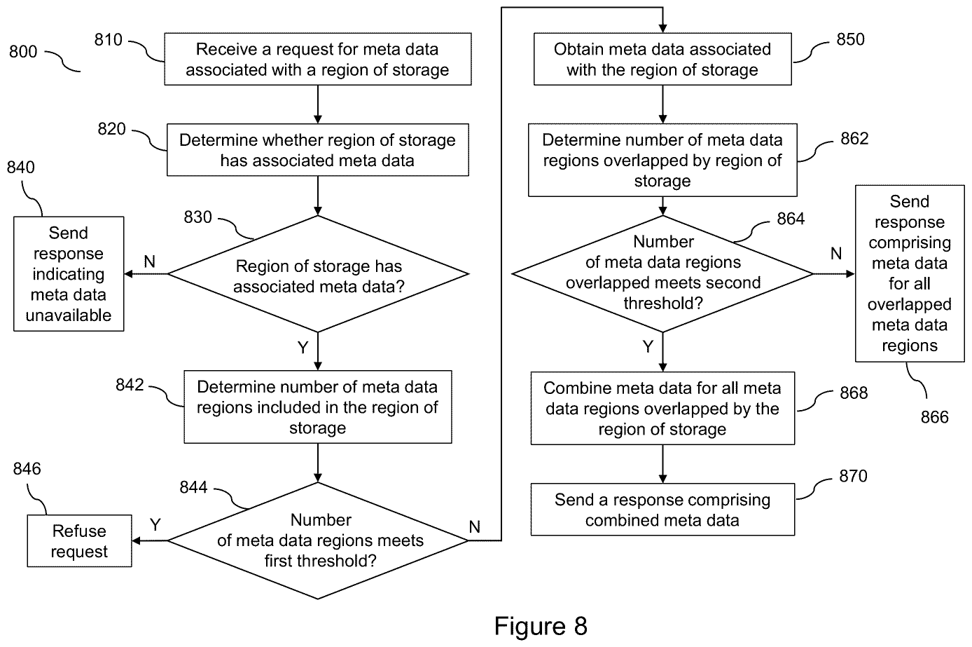

FIG. 8 shows a method 800 to be carried out at a storage controller, for example the compressor/decompressor 218 shown in FIG. 2. Advantageously, the method 800 allows the storage controller to provide information to a requestor regarding data in storage, for example data in SDRAM 216 shown in FIG. 2. In particular, the method 800 enables the storage controller to provide meta data to the requestor, providing the requestor with suitable information to decide whether to fetch data in the region of storage.

The method 800 is similar to the methods 400 and 700 described above, with similar numerals (e.g. 410/710/810 and 450/750/850) denoting similar steps. The method 800 is distinguished from the method 700 by inclusion of the steps 862, 864, 866, 868 and 870.

In a similar manner to method 700, the method 800 comprises receiving a request for meta data associated with a region of storage (step 810), determining whether the region of storage has associated meta data (step 820), if the region of storage does not have associated meta data (step 830) sending a response indicating that meta data is unavailable (step 840), if the region of storage does have associated meta data (step 830) determining the number of meta data regions included in the region of storage (step 842), if the number of meta data regions in the region of storage meets a first threshold (step 844) refusing the request (step 846) and if the number of meta data regions in the region of storage does not meet the first threshold (step 844) obtaining meta data associated with the region of storage (step 850).

At step 862, the method 800 comprises determining the number of meta data regions that are overlapped by the region of storage.

After determining the number of meta data regions that are overlapped by the region of storage at step 862, the method proceeds to step 864. At step 864, the number of meta data regions that are overlapped by the region of storage is compared with a second threshold.

In this example, the second threshold is used to ensure that the response is sent to the requestor in an efficient manner. Where the number of meta data regions overlapped by the region of storage does not meet the second threshold (e.g. the second threshold is 5 meta data regions and the number of meta data regions overlapped by the region of storage is 2) the storage controller may send meta data for all of the meta data regions to the requestor individually. Where the number of meta data regions overlapped by the region of storage meets the second threshold (e.g. the second threshold is 5 meta data regions and the number of meta data regions overlapped by the region of storage is 20) the storage controller may combine the meta data for all of the meta data regions and provide this combined meta data back to the requestor. The combined data may comprise one or more combined values corresponding to the meta data regions that are overlapped by the region of storage.

In an example, the second threshold may be 3 meta data regions and the number of meta data regions overlapped by the region of storage is 4. In this case, the storage controller will combine the meta data for each of the 4 overlapped regions. If the requestor is interested in the transparency of the data in the region of interest, then the storage controller may generate a combined transparency value corresponding to the 4 overlapped regions, with a combined transparency value of 1 corresponding to “transparent” and a combined transparency value of 0 corresponding to “not transparent”. If the meta data of each of the overlapped regions indicates that they are all transparent, then the combined transparency value will be 1. The combined meta data may be generated using a “pessimistic” approach. For example, if any of the overlapped regions indicates that they include non-transparent data, then the combined transparency value will be 0, even if most (e.g. all but one) of the overlapped regions contain only transparent data. If it is determined at step 864 that the number of meta data regions overlapped by the region of storage does not meet the second threshold, then the “N” branch from step 864 is followed. On following the “N” branch from step 864, the method 800 proceeds to step 866 where a response comprising meta data for all overlapped meta data regions is sent to the requestor.

If it is determined at step 864 that the number of meta data regions overlapped by the region of storage meets the second threshold, then the “Y” branch from step 864 is followed. On following the “Y” branch from step 864, the method 800 proceeds to step 868 where meta data for all meta data regions overlapped by the region of storage is combined.

At step 870, the method 800 comprises sending a response comprising the combined meta data to the requestor.

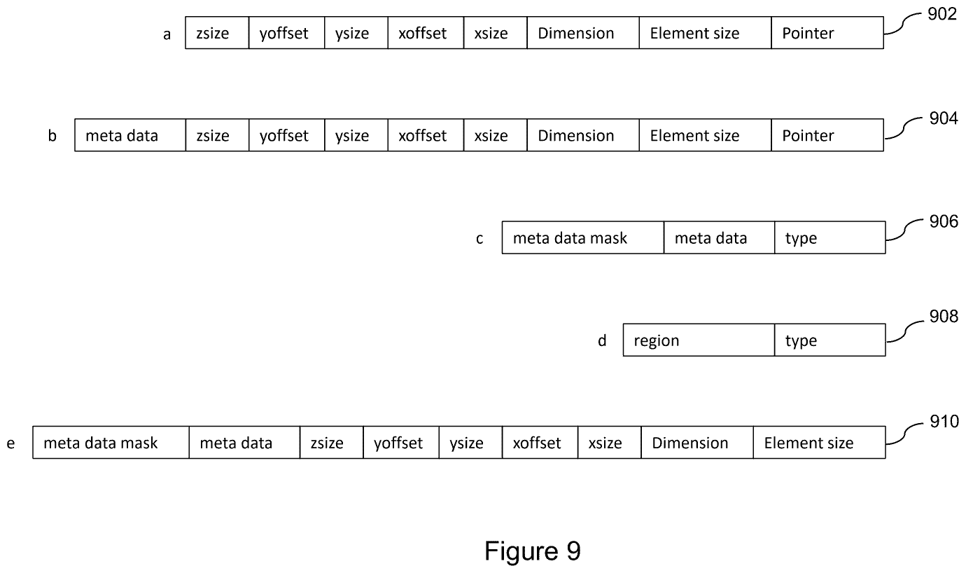

FIG. 9 shows example requests 902, 904 (panels a and b) and responses 906, 908, 910 (panels c, d and e) which may be sent to and from the storage controller, such as the DMC 214 shown in FIG. 2, respectively.

The example requests 902, 904 shown in panels a and b may be sent from the requestor to the storage controller, for example in step 510 of method 500. The request may only have region information (panel a), or the request may comprise both region and meta data information (panel b). For the requests 902, 904 in panels a and b of FIG. 9:
‘Pointer’ is a pointer to a storage region;
‘Element size’ is the data size of the element e.g. nibble, byte, 16-bit word, 32-bit word, 64-bit word;
‘Dimension’ indicates the number of dimensions of the region of storage, in this example the scheme supports three dimension types: 2′b00 representing 1D, 2′b01 representing 2D and 3′b10 representing 3D;
‘xsize’ indicates the x size in element size units;
‘xoffset’ indicates an xoffset;
‘ysize’ indicates the y size;
‘yoffset’ indicates a y offset; and
‘zsize’ indicates a z size.

For the request 904 comprising both region and meta data information (panel b) the “meta data” field indicates the meta data of interest, such as one or more of transparency information, opaqueness information, all zero information, all same value information and/or compression information.

As noted above with respect to e.g. step 410 of method 400 and step 510 of method 500, when sending a request to the storage controller, the requestor will indicate a region of storage that it is interested in. In particular, the requestor may be interested in a region of storage which is a 1D storage region, a 2D storage region or a 3D storage region. The requestor may indicate the region of storage using size and offset values. For example, in the case of a 1D storage region, the region of storage may be indicated via a size value which indicates the size in element size units, and offset value which indicates the offset of the start of the region of storage from e.g. 0.

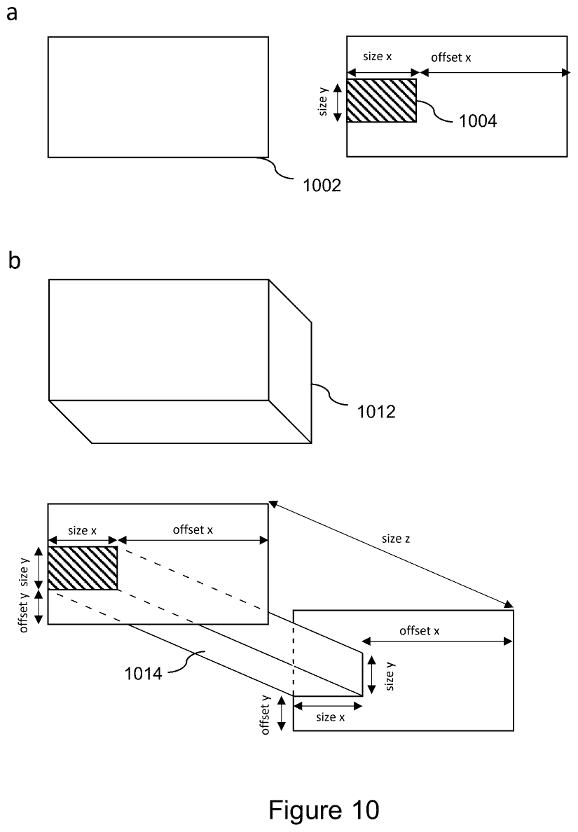

FIG. 10 shows example sizes and offsets which may be used in the cases of 2D and 3D storage regions. In particular, panel a of FIG. 10 shows a 2D storage region 1002 and a region of interest 1004, the region of interest 1004 being defined by size x, offset x, size y and offset y. Panel a of FIG. 10 shows a 3D storage region 1012 and a region of interest 1014, the region of interest 1014 being defined by size x, offset x, size y, offset y and a size z.

Returning to FIG. 9, the example responses 906, 908, 910 shown in panels c, d and e may be received by the requestor from the storage controller, for example in step 520 of method 500. There are a number of possible example responses having various combinations of fields, as shown in panels c, d and e of FIG. 9, in which:
‘type’ indicates the type of response e.g. 2′b00 representing ‘meta data available’, 2′b01 representing ‘no meta data available’ (c.f. step 440 of method 400), 2′b10 representing ‘too many regions’ (c.f. step 746 of method 700) and 2′b11 representing ‘N/A’;
‘meta data’ indicates the meta data;
‘meta data mask’ indicates a mask indicating which meta data entries are valid;
‘region’: if ‘type’ is 2′b11, the ‘region’ field indicates the number of regions covered
‘Element size’ is the data size of the element e.g. nibble, byte, 16-bit word, 32-bit word, 64-bit word;
‘Dimension’ indicates the number of dimensions of the region of storage, in this example the scheme supports three dimension types: 2′b00 representing 1D, 2′b01 representing 2D and 3′b10 representing 3D;
‘xsize’indicates the x size in element size units;
‘xoffset’ indicates an xoffset;
‘ysize’ indicates the y size;
‘yoffset’ indicates a y offset; and
‘zsize’indicates a z size.

The simplest response is response 906, shown in panel c of FIG. 9. Response 906 may provide all the information required by the requestor. Response 906 may be the only supported type of response.

If a request covers multiple compression regions, more complex responses may be supported. For example, complex responses 908, 910 are shown in panels d and e of FIG. 9. When a request covers multiple compression regions, an initial response 908 may be provided to the requestor. The initial response 908 indicates that the response is complex (i.e. contains multiple regions) and covers a number of regions, indicted in the region field. A number of further responses 910 are then provided to the requestor. The number of further responses corresponds to the number of regions indicated in the region field of the initial response 908. The complex response type 908/910 provides information (meta data) on each of the compression regions covered in the original request, and therefore must provide information on the size of each compression region.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware. Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A method at a storage controller, the method comprising:
receiving, from a requestor, a request for meta data associated with a region of storage, wherein the request comprises an indication of the region of storage; and
determining whether the region of storage has associated meta data, wherein when the region of storage has associated meta data, the method further comprises:
obtaining the meta data associated with the region of storage; and
sending, to the requestor, a response based at least in part on the associated meta data.

2. The method of claim 1, wherein the region of storage has associated meta data when the region of storage comprises compressed data.

3. The method of claim 1, wherein the meta data is meta data associated with the region of storage or computed from the region of storage.

4. The method of claim 1, wherein the response based at least in part on the associated meta data comprises an indication of the number of meta data regions included in the region of storage.

5. The method of claim 3, wherein the response based at least in part on the associated meta data comprises meta data associated with each meta data region included in the region of storage.

6. The method of claim 4, wherein the response based at least in part on the associated meta data further comprises information about one or more characteristics of interest, wherein the one or more characteristics of interest include one or more of transparency information, opaqueness information, all zero information, all same value information and compression information.

7. The method of claim 1, wherein the method further comprises:
determining a number of meta data regions included in the region of storage; and
comparing the number of meta data regions included in the region of storage with a first threshold,
wherein when the number of meta data regions included in the region of storage meets the first threshold, the method comprises refusing the request, and
wherein when the number of meta data regions included in the region of storage does not meet the first threshold, the method comprises accepting the request.

8. The method of claim 1, wherein the method further comprises:
determining a number of meta data regions that are overlapped by the region of storage; and
comparing the number of meta data regions that are overlapped by the region of storage with a second threshold,
wherein when the number of meta data regions that are overlapped by the region of storage meets the second threshold, the method comprises:
sending, to the requestor, a response comprising the meta data for all meta data regions that are overlapped by the region of storage, and
wherein when the number of meta data regions that are overlapped by the region of storage does not meet the second threshold, the method comprises:
combining the meta data for all meta data regions that are overlapped by the region of storage; and
sending, to the requestor, a response comprising the combined meta data for all meta data regions that are overlapped by the region of storage.

9. The method of claim 8, wherein the combined meta data comprises at least one combined value corresponding to the meta data regions that are overlapped by the region of storage.

10. The method of claim 1, wherein obtaining the meta data associated with the region of storage comprises reading header data and wherein the header data comprises a pointer to a body block containing compressed data.

11. The method of claim 10, wherein the header data comprises information about one or more characteristics of interest, wherein the one or more characteristics of interest include one or more of transparency information, opaqueness information, all zero information, all same value information and compression information.

12. The method of claim 1, wherein determining whether the region of storage has associated meta data comprises:
determining whether the region of storage has associated meta data that is relevant for the requestor.

13. The method of claim 1, wherein the region of storage is a 1D storage region, a 2D storage region or a 3D storage region.

14. A method at a requestor, the method comprising:
sending, to a storage controller, a request for meta data associated with a region of storage, wherein the request comprises an indication of the region of storage;
receiving, from the storage controller, a response based on the associated meta data; and
determining, based at least in part on the response from the storage controller, whether to fetch data in the region of storage.

15. The method of claim 14, wherein the indication of the region of storage comprises size information and offset information.

16. The method of claim 14, wherein the request comprises an indication of one or more characteristics of interest, wherein the one or more characteristics of interest include one or more of transparency information, opaqueness information, all zero information, all same value information and compression information, and wherein the method further comprises:
sending, to the storage controller, a request for at least some of the data in the region of storage.

17. The method of claim 16, wherein if the response based on the associated meta data is not available to the requestor within a predetermined amount of time, the request for at least some of the data in the region of storage is sent to the storage controller before the response based on the associated meta data is received from the storage controller.

18. A system comprising a storage controller, the storage controller being configured to carry out a method comprising:
receiving, by the storage controller from a requestor, a request for meta data associated with a region of storage, wherein the request comprises an indication of the region of storage; and
determining, by the storage controller, whether the region of storage has associated meta data,
wherein when the region of storage has associated meta data, the method further comprises:
obtaining, by the storage controller, the meta data associated with the region of storage; and
sending, from the storage controller to the requestor, a response based at least in part on the associated meta data.

19. The system of claim 18, wherein the system further comprises:
the requestor;
a system interconnect; and
a storage element comprising the region of storage,
wherein the storage controller is in communication with the requestor via the system interconnect, and
wherein the storage controller is in communication with the storage element comprising the region of storage.

20. The system of claim 18, wherein the system comprises a compressor and/or a decompressor and wherein the requestor is a CPU, a GPU or a display controller.
